(19) United States
(12) Patent Application Publication
(10) Pub. No.: US 2010/0190373 A1
(43) Pub. Date: Jul. 29, 2010

(54) Flat cable connector

(76) Inventor: Shih-Kun Yeh, Taoyuan Hsieh (TW)

Correspondence Address: Jackson Intellectual Property Group PLLC, 106 Starvale Lane, Shipman, VA, 22971, US

(21) Appl. No.: 12/010,223

(22) Filed: Jan. 22, 2008

(51) Int. Cl. H01R 12/24

(52) U.S. Cl. 439/499

(57) ABSTRACT

The present invention provides a flat cable connector including a set of flat cable with a contact portion, a connector body with a containing groove and a plurality of terminals, at least one fixing element and a cover. The fixing element is provided for fixing the flat cable into the containing groove, and the cover is fixed at the containing groove for protecting the terminal and the flat cable in the containing groove, while pressing the flat cable, such that the contact portion is securely contacted and electrically conducted with the terminal. The invention provides a flat cable connector featuring a convenient and quick installation, a secured structure and an easy way of changing components.

### BACKGROUND OF THE INVENTION

1. Field of the Invention

The present invention relates to a flat cable connector applicable for various types of signal bridge converters.

2. Description of the Related Art

In general, a digital electric device such as a personal computer or a LCD TV, usually comes with a transmission interface such as a universal serial bus (USB) which is an external bus standard for connecting related peripherals, in addition to a built-in motherboard (hereinafter referred to as a main board), so that the electric device can be connected to a USB device. In fact, the main board of many digital electric devices further builds a port with a serial advanced technology attachment (SATA), a high definition multimedia interface (HDMI) or a D-sub transmission interface for connecting other devices of different specifications.

An electric device generally requires a connecting cable for a signal transduction as shown in FIG. 1, and the connecting cable 80 is composed of a cable 81 with a connector 82 disposed separately on both ends of the cable 81, and the connector 82 further comprises a terminal module 83 for an electric connection, so that the connecting cable 80 can be connected to a port 90 of an electric device through the connector 82 for the signal transduction. However, the aforementioned connector 82 is integrally formed to cover the cable 81 and the terminal module 83, and thus incurring higher production, assembling and manufacturing costs. In case the cable 81 is damaged or its length is not long enough for an application, it is necessary to replace the whole connecting cable 80. Obviously, the overall applicability of such arrangement is not as good as expected.

### SUMMARY OF THE INVENTION

In view of the shortcomings of the prior art, the inventor of the present invention based on years of experience in the related industry to conduct extensive researches and experiments, and finally developed a flat cable connector in accordance with the present invention to overcome the shortcomings of the prior art.

Therefore, it is a primary objective of the present invention to provide a flat cable connector comprising a set of flat cable, a connector body, at least one fixing element and a cover, wherein an end of the flat cable has a contact portion; the connector body has a containing groove for receiving a flat cable and a plurality of terminals, and the fixing element is provided for fixing the flat cable into the containing groove, and the cover is fixed to the containing groove of the connector body for protecting the terminal and the flat cable in the containing groove, while pressing the flat cable to ensure a secured contact of the contact portion with the terminal for an electric conduction. The present invention provides a flat cable connector featuring a secured structure that can be applied to various types of signal bridge converters.

Compared with the aforementioned prior arts, the present invention has the following advantages and effects:

1. The flat cable of the flat cable connector in accordance with the invention is fixed into the containing groove by the fixing element to effectively improve the overall structural stability and prevent the flat cable from falling off or being electrically disconnected.

2. The flat cable is modularized, and thus greatly simplifying the production procedure and lowering the manufacturing cost.

3. The flat cable is simply fixed into the containing groove by the fixing element, so that if the flat cable is damaged or its length is not long enough, we just need to replace the flat cable instead of the whole flat cable connector.

### BRIEF DESCRIPTION OF THE DRAWINGS

FIG. 1 shows a schematic view of a structure of a traditional connector;

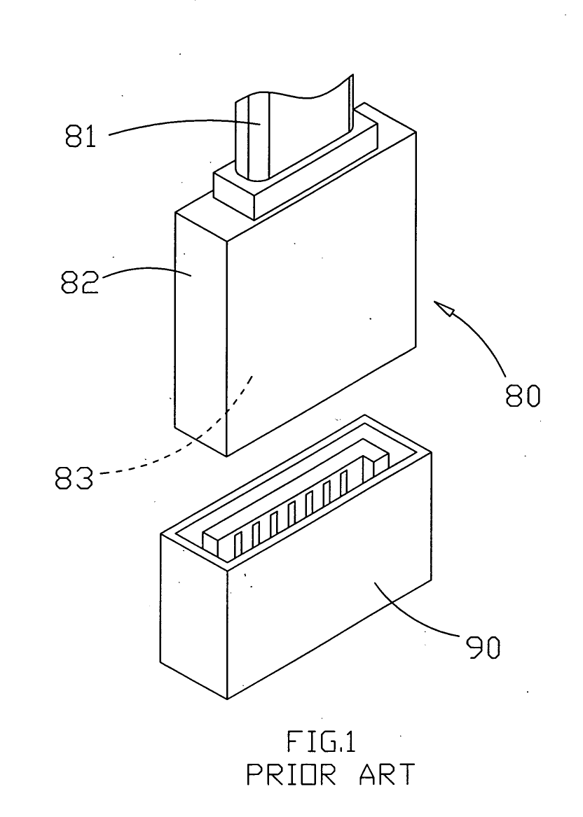

FIG. 2 shows a perspective view of a flat cable connector in accordance with a first preferred embodiment of the present invention;

FIG. 3 shows an exploded view of a flat cable connector in accordance with a first preferred embodiment of the present invention;

FIG. 4 shows an exploded view of a flat cable connector in accordance with a second preferred embodiment of the present invention;

FIG. 5 shows an exploded view of a flat cable connector in accordance with a third preferred embodiment of the present invention;

FIG. 6 shows an exploded view of a flat cable connector in accordance with a fourth preferred embodiment of the present invention;

FIG. 7 shows an exploded view of a flat cable connector in accordance with a fifth preferred embodiment of the present invention; and

FIG. 8 shows an exploded view of a flat cable connector in accordance with a sixth preferred embodiment of the present invention.

### DETAILED DESCRIPTION OF THE PREFERRED EMBODIMENTS

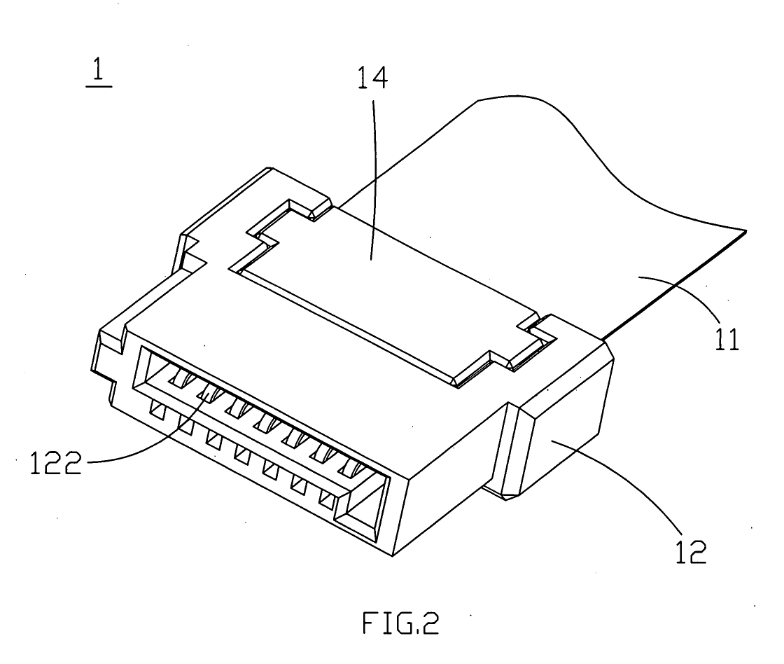

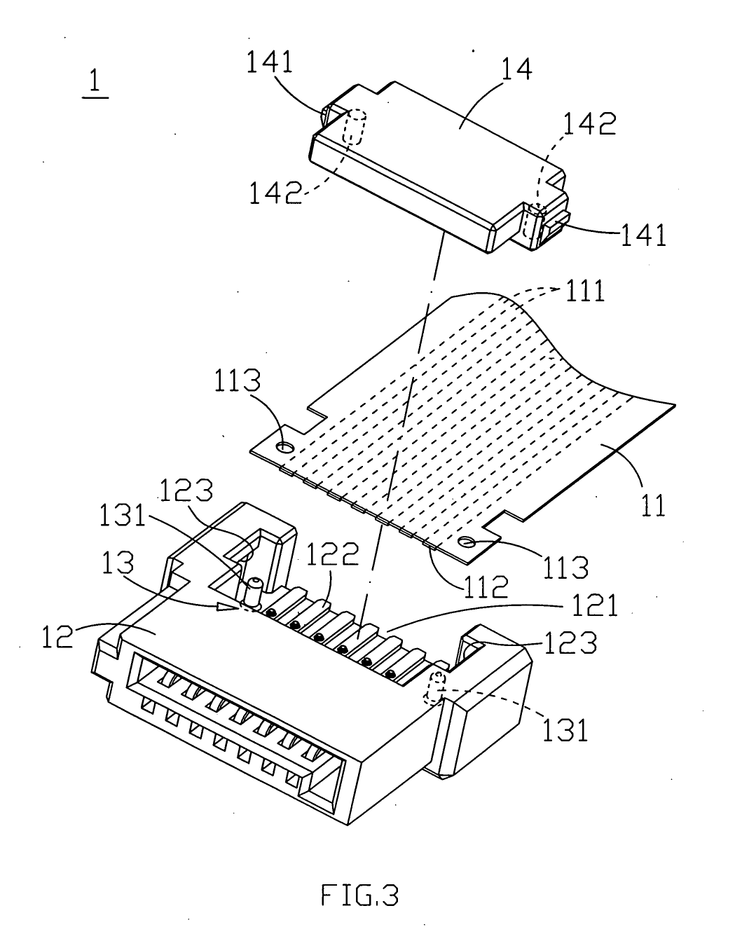

Referring to FIGS. 2 and 3 for a flat cable connector of the present invention, the flat cable connector can be applied to various types of signal bridge converters, and provides a convenient and quick installation, a secured structure, and a function of changing components easily. In this embodiment, the overall flat cable connector 1 basically comprises: a set of flat cable 11, a connector body 12, and at least one fixing element 13 and a cover 14.

The flat cable 11 comprises a core 111, a contact portion 112 exposed from an end of the flat cable 11, and a hole 113 disposed at the flat cable 11 and separately on both sides of the contact portion 112.

The connector body 12 comprises a containing groove 121 for receiving the flat cable 11 and a plurality of terminals 122, and each terminal 122 is extended into the containing groove 121, and an opening of the containing groove 121 faces upward, and both sides of the containing groove 121 separately have a latch groove 123 corresponding to the position of the wall of the containing groove 121.

The fixing element 13 is a pillar 131 installed in the containing groove 121 and disposed separately on both sides of the terminal 122 for fixing the flat cable 11 into the containing groove 121.

The cover 14 is covered downward and fixed to the containing groove 121 of the connector body 1. for protecting the terminal 122 and the flat cable 11 in the containing groove 121. A hook 141 is disposed separately on both external walls of the cover 14 and latched to the latch groove 123 corresponding to the containing groove 121, and the bottom of the cover 14 further comprises a latch portion 142 disposed at a position corresponding to the pillar 131.

In the preferred embodiment, the flat cable 11 is passed through the hole 113 and fixed by the pillar 131 in the containing groove 121 of the connector body 12, and then the cover 14 is covered onto the containing groove 121 of the connector body 12, and the cover 14 is latched with the latch groove 123 of the containing groove 121 by the hook 141 to prevent the cover 14 from falling off. Now, the latch portion 142 at the bottom of the cover 14 is latched to the pillar 131 and pressed onto the flat cable 11, such that the contact portion 112 is in a good contact with the terminal 122 for an electric conduction, so as to constitute the assembling and installation of the whole flat cable connector 1.

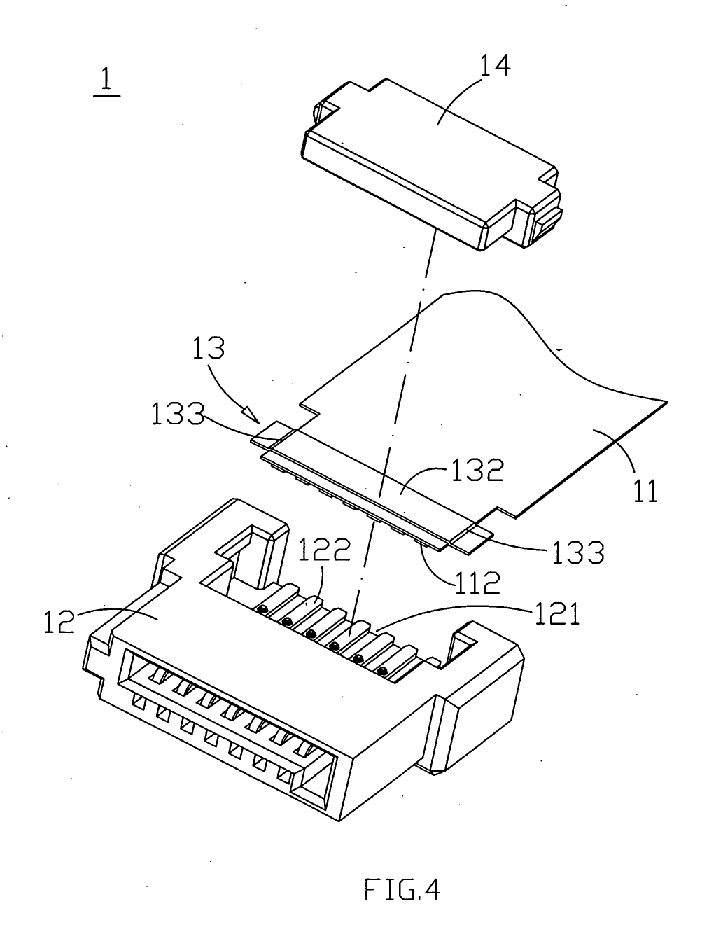

In FIG. 4, the fixing element 13 is a press board 132 installed at the flat cable 11 and proximate to the contact portion 112, wherein the length of the press board 132 is greater than the width of the flat cable 11, and both ends of the press board 132 have a cascade portion 133 each, and the height of the cascade portion 133 is substantially equal to the thickness of the flat cable 11, such that when the press board 132 is pressed and engaged with an end of the flat cable 11, both ends of the press board 132 are exposed from the flat cable 11, and fixed into the containing groove 121 by a soldering process, and the press board 132 fixes the flat cable 11 into the containing groove 121.

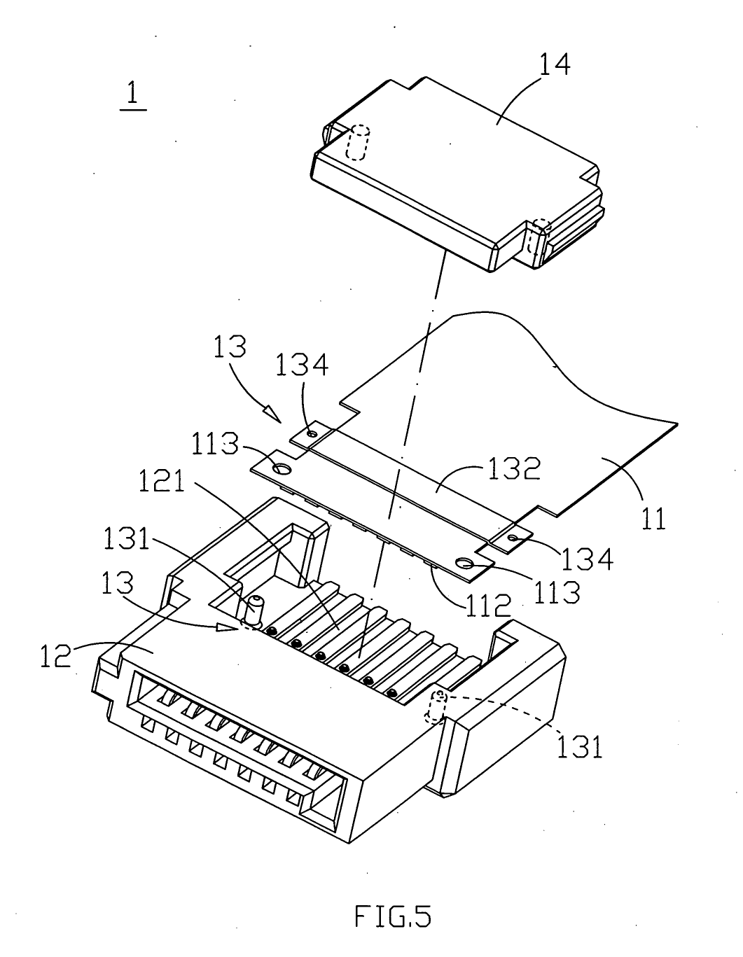

In FIG. 5, both of the containing groove 121 and the flat cable 11 have a fixing element 13, such as a pillar 131 in the containing groove 121 that is fixed to the press board 132 on the flat cable 11, and the flat cable 11 comes with a hole 113 sheathed by the pillar 131 in the containing groove 121 of the connector body 12, and the press board 132 fixes the flat cable 11 into the containing groove 121 to achieve a secured fixing effect. In the figure, both ends of the press board 132 further include a groove hole 134 for increasing the soldering area to provide a more secured effect of soldering the press board 132 into the containing groove 121.

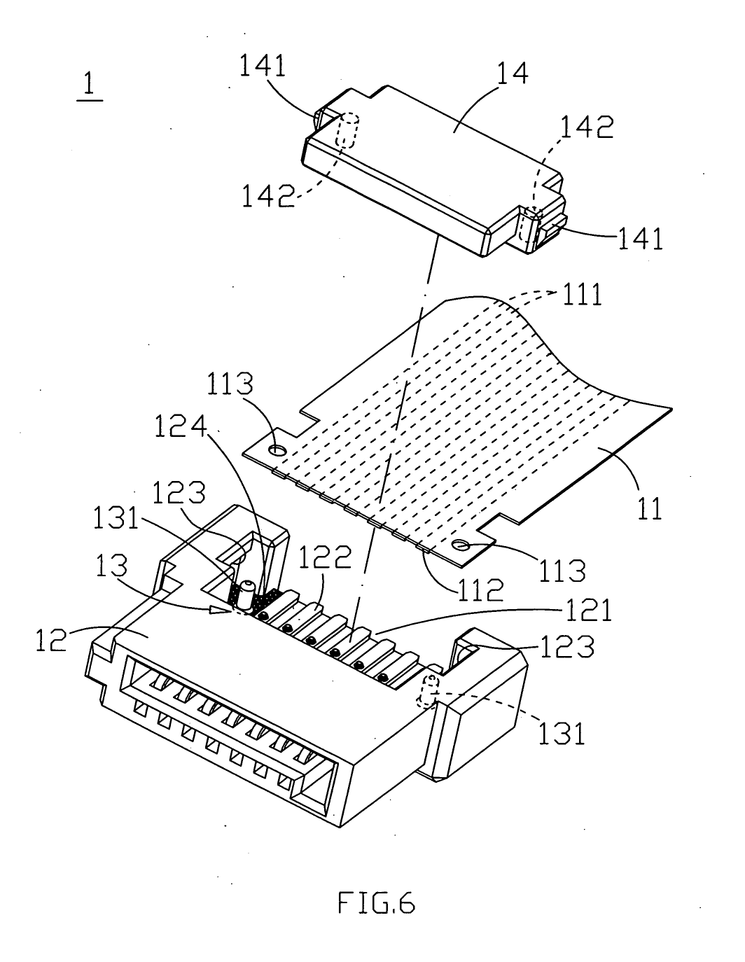

In FIG. 6, the bottom of the containing groove 121 has a rubbing portion 124 for providing a friction between the containing groove 121 and the flat cable 11 to prevent the flat cable 11 from sliding, in addition to the effect of fixing the flat cable 11 by the fixing element 13.

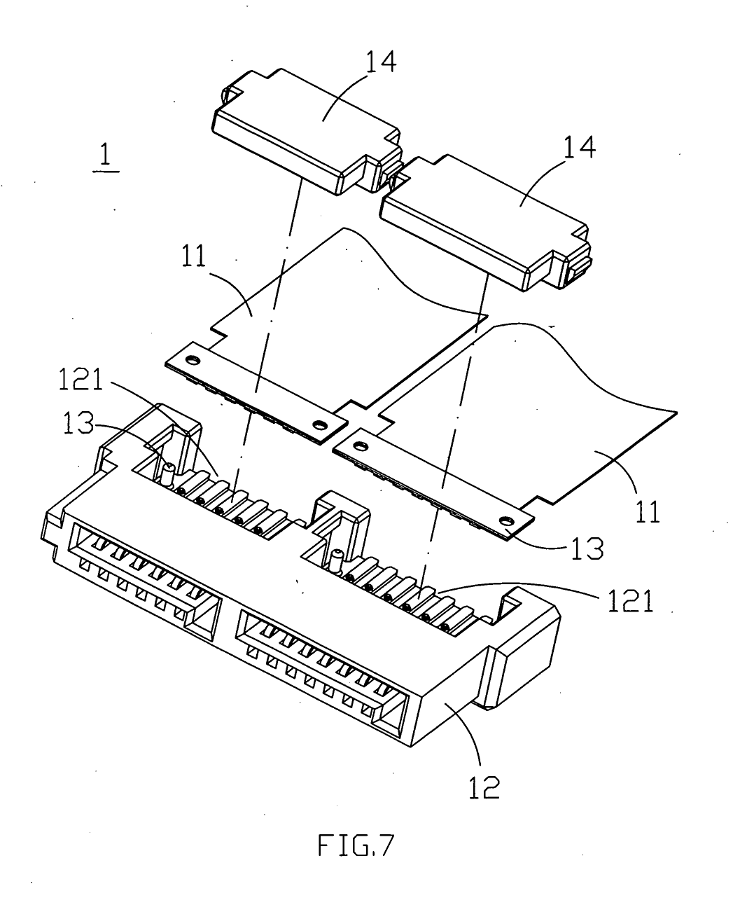

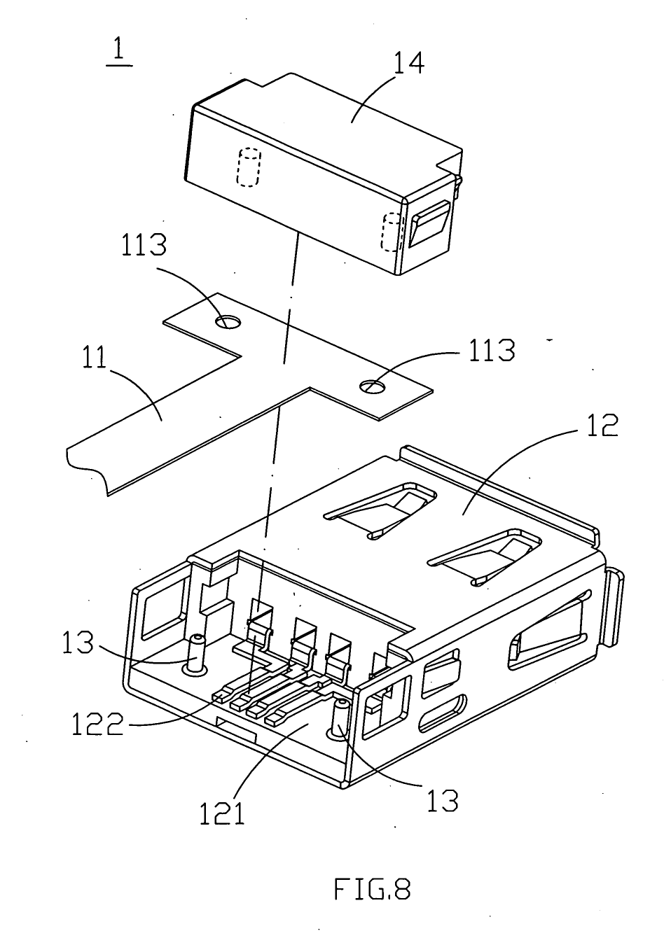

Of course, the flat cable connector 1 of the invention can be applied to a single-head serial advanced technology attachment (SATA) signal bridge converter as shown in FIGS. 2 to 5, a double-head serial advanced technology attachment (SATA) signal bridge converter as shown in FIG. 7, a universal serial bus (USB) bridge converter as shown in FIG. 8, or a low voltage differential signal (LVDS) bridge converter, a secure digital music initiative (SDMI) signal bridge converter or a high definition multimedia interface (HDMI) signal bridge converter .

With the design of connecting the cover and the connector body to the flat cable by an assembling and pressing structure, the invention can greatly simplify the production procedure and lower the manufacturing cost. The length of the flat cable can be changed as needed, and particularly the fixing element can be used for securing the flat cable into the connector body.

While the invention has been described by means of specific embodiments, numerous modifications and variations could be made thereto by those skilled in the art without departing from the scope and spirit of the invention set forth in the claims.

What is claimed is:

1. A flat cable connector, comprising:
a set of flat cable, having a contact portion disposed at an end of the flat cable;
a connector body, having a containing groove for receiving a flat cable and a plurality of terminals, and each terminal being extended into the containing groove;
at least one fixing element, for fixing the flat cable into the containing groove; and
a cover, fixed to the containing groove of the connector body, for protecting the terminal and the flat cable in the containing groove.

2. The flat cable connector of claim 1, wherein the fixing element is a pillar installed in the containing groove and disposed separately on both sides of the terminal.

3. The flat cable connector of claim 2, wherein the flat cable has a hole disposed at a position corresponding to the pillar for passing the pillar, and the cover has a latch portion disposed at a position corresponding to the pillar.

4. The flat cable connector of claim 1, wherein the fixing element is a press board, and the press board is fixed to the flat cable and disposed proximate to the contact portion.

5. The flat cable connector of claim 4, wherein the press board comes with a length greater than the width of the flat cable, such that when the press board is pressed and engaged with an end of the flat cable, both ends of the press board are exposed from the flat cable and coupled with the containing groove.

6. The flat cable connector of claim 5, wherein the press board has a cascade portion disposed separately on both ends of the press board, and the height of the cascade portion is substantially equal to the thickness of the flat cable.

7. The flat cable connector of claim 5, wherein the press board has a groove hole disposed separately on both ends of the press board.

8. The flat cable connector of claim 1, wherein the connector body containing groove comes with an opening facing upward, and the cover is covered downward onto the containing groove.

9. The flat cable connector of claim 1, wherein the containing groove has a rubbing portion disposed at the bottom of the containing groove.

10. The flat cable connector of claim 1, wherein the flat cable connector is applied to SATA, LVDS, SDMI, HDMI or USB.

11. A flat cable connector, comprising:
a set of flat cable, having a contact portion disposed at an end of the flat cable;
a connector body, having a containing groove for receiving a flat cable and a plurality of terminals, and each terminal being extended into the containing groove;
at least one fixing element, which is a pillar installed in the containing groove and disposed separately on both sides of the terminal, for fixing the flat cable into the containing groove; and
a cover, fixed to the containing groove of the connector body, for protecting the terminal and the flat cable in the containing groove.

12. The flat cable connector of claim 11, wherein the flat cable has a hole disposed at a position corresponding to the pillar for passing the pillar, and the cover has a latch portion disposed at a position corresponding to the pillar.

13. The flat cable connector of claim 11, wherein the connector body containing groove comes with an opening facing upward, and the cover is covered downward onto the containing groove.

14. The flat cable connector of claim 11, wherein the containing groove has a rubbing portion disposed at the bottom of the containing groove.

15. A flat cable connector, comprising:
a set of flat cable, having a contact portion disposed at an end of the flat cable;
a connector body, having a containing groove for receiving a flat cable and a plurality of terminals, and each terminal being extended into the containing groove;
at least one fixing element, which is a press board fixed on the flat cable and disposed proximate to the contact portion, for fixing the flat cable into the containing groove; and
a cover, fixed to the containing groove of the connector body, for protecting the terminal and the flat cable in the containing groove.

16. The flat cable connector of claim 15, wherein the press board comes with a length greater than the width of the flat cable, such that when the press board is pressed and engaged with an end of the flat cable, both ends of the press board are exposed from the flat cable and coupled with the containing groove.

17. The flat cable connector of claim 15, wherein the press board has a cascade portion disposed separately on both ends of the press board, and the height of the cascade portion is substantially equal to the thickness of the flat cable.

18. The flat cable connector of claim 15, wherein the press board has a groove hole disposed separately on both ends of the press board.

19. The flat cable connector of claim 15, wherein the connector body containing groove comes with an opening facing upward, and the cover is covered downward onto the containing groove.

20. The flat cable connector of claim 15, wherein the containing groove has a rubbing portion disposed at the bottom of the containing groove.
